(19) United States
(12) Patent Application Publication
(10) Pub. No.: US 2025/0119860 A1
(43) Pub. Date: Apr. 10, 2025

(54) MOBILITY REGISTRATION UPDATE REQUIRED AFTER REJECTION IN ANOTHER RADIO ACCESS TECHNOLOGY IN MOBILE COMMUNICATIONS

(71) Applicant: MediaTek Singapore Pte. Ltd., Singapore (SG)

(72) Inventors: Marko NIEMI, Oulu (FI); Puneet PUNEET, Bengaluru (IN); Matti MOISANEN, Oulu (FI)

(21) Appl. No.: 18/730,500

(22) PCT Filed: Apr. 17, 2023
(86) PCT No.: PCT/CN2023/088658

§ 371 Date: Jul. 19, 2024

(30) Foreign Application Priority Data
May 9, 2022 (IN) 202221026694
May 12, 2022 (IN) 202221027394

(51) Int. Cl. H04W 60/04; H04W 36/00; H04W 36/14; H04W 84/04

(52) U.S. Cl. CPC H04W 60/04; H04W 36/0079; H04W 36/14; H04W 84/042

(57) ABSTRACT

Examples pertaining to a mobility registration update (MRU) required after rejection in another radio access technology (RAT) in mobile communications are described. A user equipment (UE), after being registered in a first network, switches from the first network to camp on a second network different from the first network. The UE then switches back to camp on the first network. Next, the UE performs a mobility registration type of procedure in the first network to restore at least one parameter which was initially stored in the UE when registered in the first network before switching to the second network and later discarded during connection to the second network.

### CROSS REFERENCE TO RELATED PATENT APPLICATION(S)

The present disclosure is part of a non-provisional application claiming the priority benefit of India patents application Nos. 202221026694 and 202221027394, filed 9 May 2022 and 12 May 2022, respectively, the contents of which herein being incorporated by reference in their entirety.

### TECHNICAL FIELD

The present disclosure is generally related to mobile communications and, more particularly, to a mobility registration update (MRU) required after rejection in another radio access technology (RAT) in mobile communications.

### BACKGROUND

Unless otherwise indicated herein, approaches described in this section are not prior art to the claims listed below and are not admitted as prior art by inclusion in this section.

In wireless communications such as mobile communications in accordance with the 3rd Generation Partnership Project (3GPP) standard(s), in an event that a location update cannot be accepted by a network, the network would send a LOCATION UPDATING REJECT message to a mobile station (MS) or user equipment (UE). In such cases, the UE would need to enter a state of LOCATION UPDATING REJECTED and await release of a radio resource (RR) connection triggered by the network. Moreover, for all causes except causes #12, #15, #22 and #25, the UE would delete a list of “equivalent PLMNs.”

While a UE supporting multiple radio access technologies (RATs), such as 2^{nd} Generation (2G), 3^{rd} Generation (3G), 4^{th} Generation (4G) and 5^{th} Generation (5G) mobile communications, can be successfully registered in a 5G network, the UE may lose 5G coverage for one or more reasons and then move to a 2G or 3G network. In case that the UE gets rejected in the 2G/3G network (e.g., due to the UE not being successfully registered in the 2G/3G network) and moves back to the 5G network (e.g., when the 5G coverage is back or due to some other reason), the UE is not assumed to conduct any actions while it may be assumed that the UE is still registered in the 5G network. However, due to the rejection in the 2G/3G network, the UE may have deleted some crucial information. For example, the UE first registers in a 5^{th} Generation System (5GS) network and receives a list of equivalent public land mobile networks (PLMNs). Then, the UE camps on a 2G/3G network (for any reason) and later receives a LOCATION UPDATING REJECT message. Accordingly, the UE deletes the list of equivalent PLMNs in accordance with the 3GPP specification. However, a 5^{th} Generation Mobility Management (5GMM) of the UE is still registered and the UE camps back in the 5GS in the same tracking area (the registered one). As such, there is no registration needed, and the 5GMM stays registered, yet the list of equivalent PLMNs has been deleted. This issue needs to be addressed. Therefore, there is a need for a solution of a MRU required after rejection in another RAT in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to a MRU required after rejection in another RAT in mobile communications. It is believed that the above-described issue would be avoided or otherwise alleviated by implementing one or more of the proposed schemes described herein.

In one aspect, a method may involve a processor of an apparatus (e.g., UE), after being registered in a first network, switching from the first network to camp on a second network different from the first network. The method may also involve the processor switching back to camp on the first network. The method may further involve the processor performing a mobility registration type of procedure in the first network to restore at least one parameter which was initially stored in the UE when registered in the first network before switching to the second network and later discarded during connection to the second network.

In another aspect, an apparatus may include a transceiver and a processor coupled to the transceiver. The transceiver may be configured to communicate wirelessly. The processor may, after being registered in a first network, switch from the first network to camp on a second network different from the first network. The processor may also switch back to camp on the first network. The processor may further perform a mobility registration type of procedure in the first network to restore at least one parameter which was initially stored in the UE when registered in the first network before switching to the second network and later discarded during connection to the second network.

It is noteworthy that, although description provided herein may be in the context of certain radio access technologies, networks and network topologies such as 5G New Radio (NR) and 4G Evolved Packet System (EPS) mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a MRU required after rejection in another RAT in mobile communications. According to the present disclosure, a number of possible solutions may be implemented separately or jointly. That is, although these possible solutions may be described below separately, two or more of these possible solutions may be implemented in one combination or another.

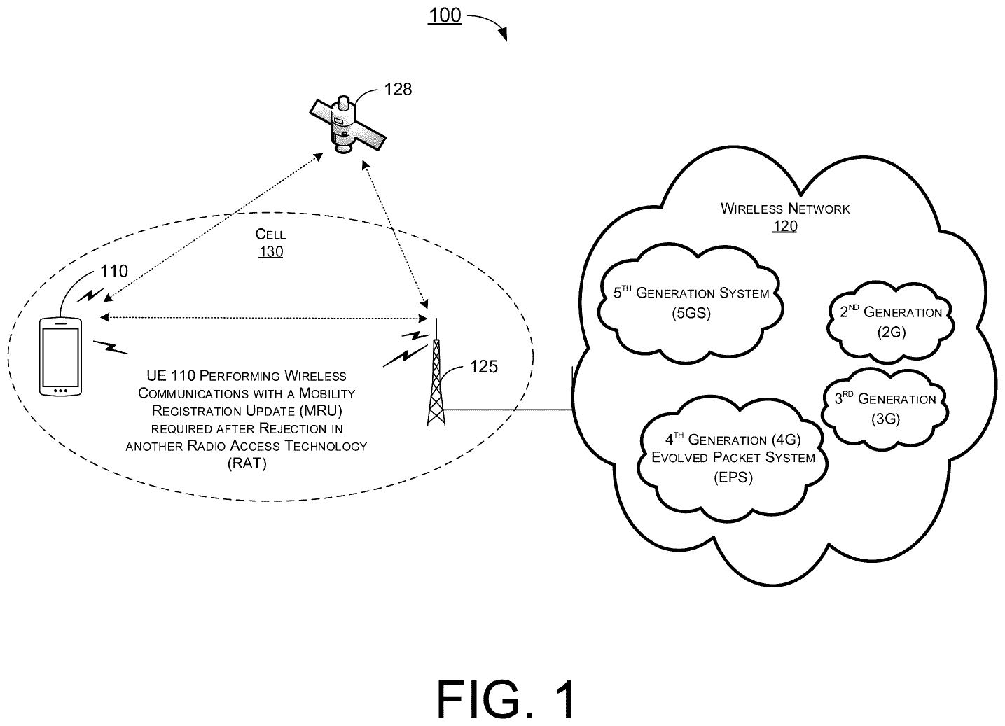

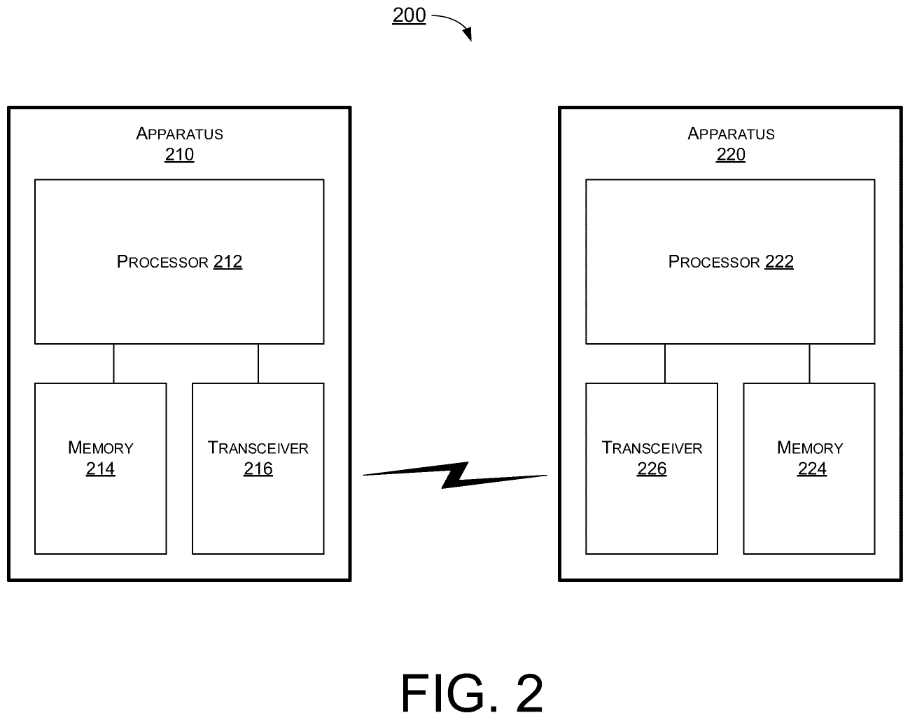

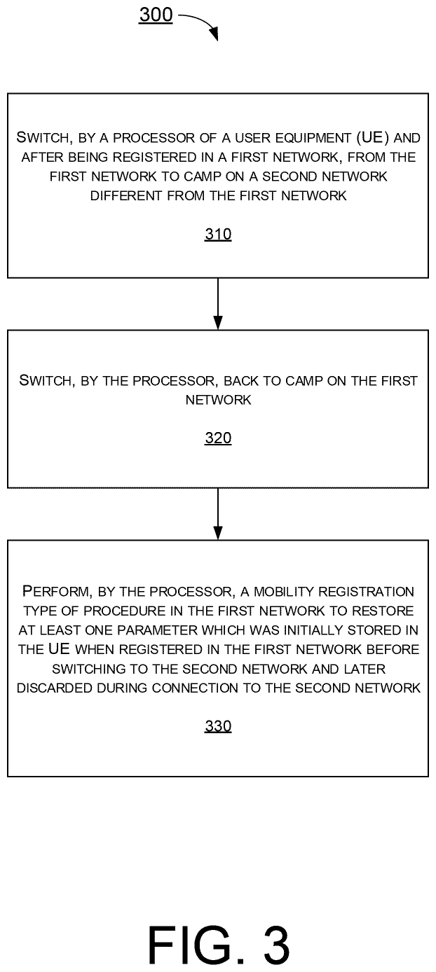

FIG. 1 illustrates an example network environment 100 in which various solutions and schemes in accordance with the present disclosure may be implemented. FIG. 2˜FIG. 3 illustrate examples of implementation of various proposed schemes in network environment 100 in accordance with the present disclosure. The following description of various proposed schemes is provided with reference to FIG. 1˜FIG. 3.

Referring to FIG. 1, network environment 100 may involve a UE 110 and a wireless network 120, which may include a 5GS, a 4G EPS, a 3G network and a 2G network. Depending on channel condition, availability and/or other factor(s), UE 110 may be in wireless communication with wireless network 120 via one or more terrestrial network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a terrestrial network node 125 (e.g., gNB, eNB or TRP) and/or a non-terrestrial network node 128 (e.g., satellite) of wireless network 120. In network environment 100, UE 110 and wireless network 120 may implement various schemes pertaining to a MRU required after rejection in another RAT in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly.

Under a proposed scheme in accordance with the present disclosure, UE 110 may perform a registration update in a network when UE 110 is registered in the network and: (i) UE 110 detects that it has lost, deleted or otherwise missing one or more pieces of information that UE 110 should have stored when it is registered in the network, or (ii) some registration related information has been modified while in other system, (e.g., the information stored from a previous successful registration procedure). For instance, the registration may be performed in a cell on which UE 110 is currently camping and the registration may involve, for example, a location area update or routing area update in 2G/3G, a tracking area update in 4G, or a mobility registration update in 5G.

Under the proposed scheme, UE 110 may first be registered in a 5GS network, which is a packet-switching (PS) domain) and UE 110 may have stored parameter(s)/information received in a REGISTRATION ACCEPT message (or later on in a CONFIGURATION UPDATE COMMAND message, for example). The stored parameter(s)/information may include, for example, a list of equivalent PLMNs. UE 110 may then camp on a 2G or 3G network (for any reason). Then, UE 110 may receive a LOCATION UPDATING REJECT message and, accordingly, UE 110 may delete the previously stored parameter(s)/information (e.g., the list of equivalent PLMNs). Later, UE 110 may camp back in 5GS in a same tracking area (TA), which may be the registered one (e.g., where the 5^{th} Generation Mobility Management (5GMM) is registered) or another TA (not in the registration area). UE 110 may need to perform a registration in 5GS with a type of “mobility registration updating” due to one or more reasons such as, for example, (un) successful location updating in the 2G or 3G network, which is a circuit-switching (CS) domain. In addition to the (un) successful location updating in the 2G/3G network or, as an alternative, a reason to perform the mobility registration update may be that UE 110 may determines that some stored information is discarded (e.g., the stored list of equivalent PLMNs is being deleted, for example, due to rejection in the 2G/3G network).

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to a MRU required after rejection in another RAT in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer 35 or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including those pertaining to a MRU required after rejection in another RAT in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 214 and memory 224 may include a UICC.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., terrestrial network node 125 or non-terrestrial network node 128) of a wireless network (e.g., wireless network 120), is provided below.

Under certain proposed schemes in accordance with the present disclosure with respect to a MRU required after rejection in another RAT in mobile communications, processor 212 of apparatus 210, implemented in or as UE 110, may, after being registered in a first network, switch, via transceiver 216, from the first network to camp on a second network different from the first network. Additionally, processor 212 may switch, via transceiver 216, back to camp on the first network. Moreover, processor 212 may perform, via transceiver 216, a mobility registration type of procedure in the first network to restore at least one parameter which was initially stored in the UE when registered in the first network before switching to the second network and later discarded during connection to the second network.

In some implementations, the at least one parameter may include a list of equivalent PLMNs.

In some implementations, the at least one parameter may include one or more parameters received in a response to a successful registration attempt or during a successful registration and stored in apparatus 210 when apparatus 210 was registered in the first network before switching to the second network.

In some implementations, the mobility registration type of procedure may include a location area update procedure, a routing area update procedure, a tracking area update procedure or a mobility registration update procedure.

In some implementations, the first network may be of a packet-switching (PS) domain, and wherein the second network is of a circuit-switching (CS) domain.

In some implementations, the first network may include an EPS network, a 5GS network or a next-generation mobile network developed after the 5GS network. In such cases, the second network may include a 2G or 3G mobile network.

In some implementations, in switching back to camp on the first network, processor 212 may switch back to camp on the first network in a same tracking area (TA) as, or a different TA than, a registered TA wherein apparatus 210 was camped on the first network before switching to the second network.

In some implementations, processor 212 may perform additional operations. For instance, processor 212 may receive, via transceiver 216, a reject message from the second network. In such cases, in switching back to camp on the first network, processor 212 may switch back to camp on the first network after receiving the reject message from the second network. Moreover, the at least one parameter was discarded responsive to receiving the reject message. In some implementations, the reject message may include a LOCATION UPDATING REJECT message.

In some implementations, processor 212 may perform other operations. For instance, processor 212 may determine that the at least one parameter has been discarded. In such cases, in performing the mobility registration type of procedure, process 300 may involve processor 212 performing the mobility registration type of procedure responsive to the determining.

### Illustrative Processes

FIG. 3 illustrates an example process 300 in accordance with an implementation of the present disclosure. Process 300 may represent an aspect of implementing various proposed designs, concepts, schemes, systems and methods described above, whether partially or entirely, including those described above. More specifically, process 300 may represent an aspect of the proposed concepts and schemes pertaining to a MRU required after rejection in another RAT in mobile communications. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively in a different order. Furthermore, one or more of the blocks/sub-blocks of process 300 may be executed iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., terrestrial network node 125 or non-terrestrial network node 128) of a network (e.g., wireless network 120). Process 300 may begin at block 310.

At 310, process 300 may involve processor 212 of apparatus 210, implemented in or as UE 110, after being registered in a first network, switching, via transceiver 216, from the first network to camp on a second network different from the first network. Process 300 may proceed from 310 to 320.

At 320, process 300 may involve processor 212 switching, via transceiver 216, back to camp on the first network. Process 300 may proceed from 320 to 330.

At 330, process 300 may involve processor 212 performing, via transceiver 216, a mobility registration type of procedure in the first network to restore at least one parameter which was initially stored in the UE when registered in the first network before switching to the second network and later discarded during connection to the second network.

In some implementations, the at least one parameter may include a list of equivalent PLMNs.

In some implementations, the at least one parameter may include one or more parameters received in a response to a successful registration attempt or during a successful registration and stored in apparatus 210 when apparatus 210 was registered in the first network before switching to the second network.

In some implementations, the mobility registration type of procedure may include a location area update procedure, a routing area update procedure, a tracking area update procedure or a mobility registration update procedure.

In some implementations, the first network may be of a PS domain, and wherein the second network is of a CS domain.

In some implementations, the first network may include an EPS network, a 5GS network or a next-generation mobile network developed after the 5GS network. In such cases, the second network may include a 2G or 3G mobile network.

In some implementations, in switching back to camp on the first network, process 300 may involve processor 212 switching back to camp on the first network in a same TA as, or a different TA than, a registered TA wherein apparatus 210 was camped on the first network before switching to the second network.

In some implementations, process 300 may involve processor 212 performing additional operations. For instance, process 300 may involve processor 212 receiving, via transceiver 216, a reject message from the second network. In such cases, in switching back to camp on the first network, process 300 may involve processor 212 switching back to camp on the first network after receiving the reject message from the second network. Moreover, the at least one parameter was discarded responsive to receiving the reject message. In some implementations, the reject message may include a LOCATION UPDATING REJECT message.

In some implementations, process 300 may involve processor 212 performing other operations. For instance, process 300 may involve processor 212 determining that the at least one parameter has been discarded. In such cases, in performing the mobility registration type of procedure, process 300 may involve processor 212 performing the mobility registration type of procedure responsive to the determining.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
switching, by a processor of a user equipment (UE) and after being registered in a first network, from the first network to camp on a second network different from the first network;
switching, by the processor, back to camp on the first network; and
performing, by the processor, a mobility registration type of procedure in the first network to restore at least one parameter which was initially stored in the UE when registered in the first network before switching to the second network and later discarded during connection to the second network.

2. The method of claim 1, wherein the at least one parameter comprises a list of equivalent public land mobile networks (PLMNs).

3. The method of claim 1, wherein the at least one parameter comprises one or more parameters received in a response to a successful registration attempt or during a successful registration and stored in the UE when the UE was registered in the first network before switching to the second network.

4. The method of claim 1, wherein the mobility registration type of procedure comprises a location area update procedure, a routing area update procedure, a tracking area update procedure or a mobility registration update procedure.

5. The method of claim 1, wherein the first network is of a packet-switching domain, and wherein the second network is of a circuit-switching domain.

6. The method of claim 1, wherein the first network comprises an Evolved Packet System (EPS) network, a 5^{th} Generation System (5GS) network or a next-generation mobile network developed after the 5GS network, and wherein the second network comprises a 2^{nd} Generation (2G) or 3^{rd} Generation (3G) mobile network.

7. The method of claim 1, wherein the switching back to camp on the first network comprises switching back to camp on the first network in a same tracking area (TA) as, or a different TA than, a registered TA wherein the UE was camped on the first network before switching to the second network.

8. The method of claim 1, further comprising:
receiving, by the processor, a reject message from the second network,
wherein the switching back to camp on the first network comprises switching back to camp on the first network after receiving the reject message from the second network, and
wherein the at least one parameter was discarded responsive to receiving the reject message.

9. The method of claim 8, wherein the reject message comprises a LOCATION UPDATING REJECT message.

10. The method of claim 1, further comprising:
determining, by the processor, that the at least one parameter has been discarded,
wherein the performing of the mobility registration type of procedure comprises performing the mobility registration type of procedure responsive to the determining.

11. An apparatus implementable in a user equipment (UE), comprising:
a transceiver configured to communicate wirelessly; and
a processor coupled to the transceiver and configured to perform operations comprising:
switching, via the transceiver and after being registered in a first network, from the first network to camp on a second network different from the first network;
switching, via the transceiver, back to camp on the first network; and
performing, via the transceiver, a mobility registration type of procedure in the first network to restore at least one parameter which was initially stored in the UE when registered in the first network before switching to the second network and later discarded during connection to the second network.

12. The apparatus of claim 11, wherein the at least one parameter comprises a list of equivalent public land mobile networks (PLMNs).

13. The apparatus of claim 11, wherein the at least one parameter comprises one or more parameters received in a response to a successful registration attempt or during a successful registration and stored in the UE when the UE was registered in the first network before switching to the second network.

14. The apparatus of claim 11, wherein the mobility registration type of procedure comprises a location area update procedure, a routing area update procedure, a tracking area update procedure or a mobility registration update procedure.

15. The apparatus of claim 11, wherein the first network is of a packet-switching domain, and wherein the second network is of a circuit-switching domain.

16. The apparatus of claim 11, wherein the first network comprises an Evolved Packet System (EPS) network, a 5^{th} Generation System (5GS) network or a next-generation mobile network developed after the 5GS network, and wherein the second network comprises a 2^{nd} Generation (2G) or 3^{rd} Generation (3G) mobile network.

17. The apparatus of claim 11, wherein, in switching back to camp on the first network, the processor is configured to switch back to camp on the first network in a same tracking area (TA) as, or a different TA than, a registered TA wherein the UE was camped on the first network before switching to the second network.

18. The apparatus of claim 11, wherein the processor is further configured to perform operations comprising:
receiving, via the transceiver, a reject message from the second network,
wherein the switching back to camp on the first network comprises switching back to camp on the first network after receiving the reject message from the second network, and
wherein the at least one parameter was discarded responsive to receiving the reject message.

19. The apparatus of claim 18, wherein the reject message comprises a LOCATION UPDATING REJECT message.

20. The apparatus of claim 11, wherein the processor is further configured to perform operations comprising:
determining that the at least one parameter has been discarded,
wherein the performing of the mobility registration type of procedure comprises performing the mobility registration type of procedure responsive to the determining.
